(19) United States
(12) Patent Application Publication
(10) Pub. No.: US 2006/0290480 A1
(43) Pub. Date: Dec. 28, 2006

(54) Method and system for a mobile security network

(76) Inventors: Karsten Funk, Stuttgart (DE); Sharmila Ravula, Sunnyvale, CA (US); Madhuri Raya, Sunnyvale, CA (US)

Correspondence Address: KENYON & KENYON LLP, ONE BROADWAY, NEW YORK, NY, 10004, US

(21) Appl. No.: 11/165,988

(22) Filed: Jun. 24, 2005

(51) Int. Cl. B60R 25/10; G08B 21/00; G08B 19/00

(52) U.S. Cl. 340/426.18; 340/870.09; 340/426.2

(57) ABSTRACT

A mobile security network includes a plurality of primary mobile nodes and at least one secondary mobile node dynamically assigned to be monitored by one of the plurality of primary mobile nodes. The plurality of primary mobile nodes communicate with each other to hand off responsibility for monitoring the at least one secondary mobile node, and monitor a link quality between themselves and any assigned secondary mobile nodes. The network is configured to issue an alarm if a link quality between a secondary mobile node and its assigned primary mobile node falls below a predefined value for a predefined time period, and a link quality between the secondary mobile node and all non-assigned primary mobile nodes does not exceed the predefined link quality.

### FIELD OF THE INVENTION

The present invention relates to a mobile security network system and a method for operating the system.

### BACKGROUND INFORMATION

Wireless security networks may connect different types of sensors, such as door contacts, motion sensors, glass breaks sensors, etc., with a base station of the network. As soon as a particular sensor experiences an abnormal situation, the base station may be notified via a wireless protocol. To ensure the integrity of the wireless security network, the connectivity in terms of the sensor's ability to communicate with the base station, and vice versa, may be constantly checked, and this property, the so-called link quality, may be monitored by the system.

There may be several reasons to monitor the link quality between the sensor node and base station of the wireless security network. For example, if the link quality deteriorates, the network may need to switch to an alternate route and/or frequency to reach the sensor node. Another reason to monitor the link quality is that an intruder may attempt to disturb communication to this particular sensor node, in which case the system should issue an alarm.

Wireless security networks may be applied in mobile systems, including cars and other vehicles. For example, although car alarm systems may secure the interior of a car properly, any items temporarily located in or on the car may not be accommodated. Such items may include, for example, a bicycle on the roof rack, the roof rack itself, or anything in the trunk bed.

Wireless security networks may also be applied to help travelers monitor their luggage so it does not become stolen or forgotten, or to help teachers keep account of their students on field trips to make sure that no student is left behind or gets lost.

In such mobile applications, a simple wireless connection between the owner, or a guard acting on behalf of the owner, and the item to be guarded may be monitored continuously. In this regard, as soon as this link quality falls below a certain value, an alarm or notification may be issued.

Such an approach is discussed, for example, in German Published Patent Application No. 19941580. The approach described therein may be suitable for a simple applications, such as, for example, one person guarding one piece of luggage, but the approach may be limited when it is required that two or more pieces of luggage are to be watched, or when two persons have been assigned to keep track or multiple pieces of luggage. In such instances, it may be desirable if the monitoring device of one traveler could provide an alarm so soon as the second traveler carrying one piece of luggage leaves the acceptable radius of this traveler's monitoring device.

### SUMMARY OF THE INVENTION

The present invention provides a method and system to operate a wireless mobile security network.

An exemplary embodiment and/or exemplary method of the present invention is directed to a mobile security network, which includes a plurality of primary mobile nodes and at least one secondary mobile node dynamically assigned to be monitored by one of the plurality of primary mobile nodes. The plurality of primary mobile nodes communicate with each other to hand off responsibility for monitoring the at least one secondary mobile node, and monitor a link quality between themselves and any assigned secondary mobile nodes. The network is configured to issue an alarm if a link quality between a secondary mobile node and its assigned primary mobile node falls below a predefined value for a predefined time period, and if a link quality between the secondary mobile node and all non-assigned primary mobile nodes does not exceed the predefined link quality.

Another exemplary embodiment and/or exemplary method of the present invention is directed to a mobile security network, which includes a device to be monitored, and a plurality of monitoring devices to monitor the device to be monitored, the device to be monitored and the plurality of monitoring devices being mobile devices. The plurality of monitoring devices are configured to monitor a link quality with respect to the device to be monitored and communicate the monitored link quality to at least one other monitoring device, and a monitoring device is assigned responsibility for monitoring the device to be monitored based on the link quality between the device to be monitored and each of the plurality of monitoring devices. In this regard, the monitoring device assigned responsibility for monitoring the device to be monitored may be configured to issue an alarm if the link quality falls below a predefined value for a predefined time period. Alternatively, or additionally, a monitoring device not currently assigned responsibility for monitoring the device to be monitored may be configured to issue an alarm if the link quality falls below a predefined value for a predefined time period. The assigned monitoring device may also hand over responsibility to monitor the device to be monitored based on the link quality between the device to be monitored and each of the plurality of monitoring devices. For example, the assigned monitoring device may hand over responsibility to monitor the device to be monitored if the link quality between the device to monitored and a non-assigned monitoring device exceeds the link quality between the device to be monitored and the assigned monitoring device for a predefined time period.

Yet another exemplary embodiment and/or exemplary method of the present invention is directed to a mobile security network, in which the device to be monitored includes an item of personal property, or the device to be monitored is configured to be coupled with an item of personal property, and/or the monitoring devices are configured to be at least one of worn and carried by a person.

Still another exemplary embodiment and/or exemplary method of the present invention is directed to a mobile security network, in which the monitoring devices are configured to be integrated with a vehicle security system.

Yet another exemplary embodiment and/or exemplary method of the present invention is directed to monitoring a mobile device via a plurality of monitoring devices, which includes monitoring a link quality between the mobile device and each of the plurality of monitoring devices, communicating the link quality between the mobile device and each of the plurality of monitoring devices to each of the plurality of monitoring devices, assigning a monitoring device responsibility for monitoring the mobile device based on the link quality between the mobile device and the monitoring device, issuing an alarm if the link quality between the mobile device and the monitoring device assigned to monitor the mobile device falls below a predefined value for a predefined time period, and handing over to a non-assigned monitoring device responsibility to monitor the mobile device if the link quality between the mobile device and the non-assigned monitoring device exceeds the link quality between the mobile device and the assigned monitoring device for a predefined time period.

According to an exemplary embodiment and/or exemplary method of the present invention, the wireless mobile security network includes a primary network and a database to keep track of network nodes and link qualities from one or more of secondary nodes that form secondary networks. Each primary network node has an assigned secondary network so that it keeps track of the link quality to each assigned secondary network node and reports this information together with significant changes to other primary network nodes. An alarm may be issued as soon as the link quality between a primary network node and any node of its associated secondary network drops below a predefined value without the node showing up with a higher link quality on any other primary network node. The secondary network may be a physical network (e.g., differentiated in its physical properties such as different frequencies, transmission types or network protocols) or logical network (e.g., different network addresses) or just logically divided (e.g., same physical properties and same address space, separation only by grouping in databases). In this regard, appropriate measures may be provided to avoid interferences and ensure functionality.

According to an exemplary embodiment and/or exemplary method of the present invention, a secondary network node may be reassigned to another primary network node, if network properties indicate, for example, that the link quality to this primary node becomes better than to the previous primary network node or the proximity of the secondary network node to the previous primary network node decreases significantly. Proper handover of responsibility for monitoring the secondary network node may be ensured using standardized and/or proprietary methods. Additionally, it is permissible that a primary network node together with all its assigned secondary nodes may leave the primary network without triggering an alarm (e.g. the system may be set so a notification about the network configuration change will be sent to every primary network node).

### BRIEF DESCRIPTION OF THE DRAWINGS

FIG. 1 shows an exemplary wireless mobile security network, which includes primary nodes that form a primary network, and secondary nodes that form secondary networks with associated primary nodes.

FIG. 2 shows an exemplary wireless mobile security network having a primary network and two secondary networks, in which two teachers are using the primary nodes and six students are using the secondary nodes.

FIG. 3 shows the exemplary wireless mobile security network of FIG. 2, undergoing a change.

FIG. 4 shows the exemplary wireless mobile security network of FIG. 2, detecting a lost secondary node.

FIG. 5 shows the exemplary wireless mobile security network of FIG. 2, detecting a lost connection between primary nodes within the primary network.

FIG. 6 shows an exemplary method to monitor one or more mobile device via a plurality of monitoring devices.

### DETAILED DESCRIPTION

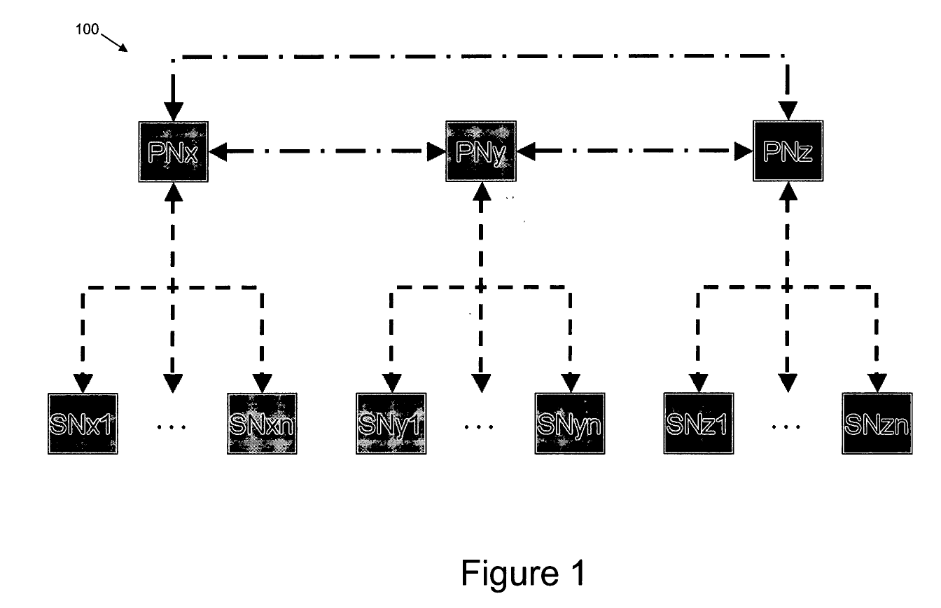

FIG. 1 shows an exemplary wireless mobile security network 100, which includes primary nodes PN_{X}, PN_{Y}, PN_{Z} that form a primary network, and secondary nodes SNₓ₁₋ₓₙ, SN_{y1-yn}, SN_{z1-zn}, that form secondary networks with an associated primary node. In this instance, primary node PN_{X} and secondary nodes SNₓ₁₋ₓₙ form a secondary network “X”, primary node PN_{Y} and secondary nodes SN_{y1-yn} form a secondary network “Y”, and primary node PN_{Z} and secondary nodes SN_{z1-zn} form a secondary network “Z”. The primary nodes may be organized in various network topologies, such as, for example, a star topology or a ring topology. The secondary networks are configured to always have a primary node as the master node in their respective network.

According to an exemplary embodiment and/or exemplary method of the present invention, the primary nodes are monitoring devices that are carried by “guards”, and the secondary nodes are devices to be monitored or tracked (i.e., “guarded devices”). Each monitoring device and associated guarded device(s) form a separate and distinct secondary network to keep track of the guarded devices. In short time periods, each monitoring device may check a link quality between itself and each of the guarded devices within its coverage area and maintain these values in a database (e.g., DBG1 for database guard 1). The monitoring devices may have access to share, and/or maintain the link quality values of each others' database (e.g., DBG1, DBG2, etc.) and/or shared databases (e.g., a global network database), so that at every point in time, each monitoring device “knows” which guarded device is under the watch of which monitoring device. In other words, every node in the primary network knows at every point in time (or at least within its link quality check time periods) which secondary node is part of the network and which primary node device is keeping track of it (i.e., which node on the primary network is responsible for each node on the secondary network within the primary network).

A primary network database may be configured to handover responsibility for monitoring a particular secondary node if the particular secondary node leaves the coverage area of a primary node but shows up in the coverage area of another primary node. The overall system still “sees” the secondary node as part of the overall network, but the primary node device assigned to monitor the transient secondary node changes (e.g., PN_{X} to PN_{Y}). This may be accomplished, for example, using a handover algorithm, e.g., a ‘handshake’ between the two primary nodes, to assure proper release and capture of the secondary nodes. Other safeguards may be provided to ensure system integrity, such as, for example, using encryption and unique identifiers so that (secondary) nodes belonging to the network are accepted (by primary nodes) which may change responsibility and vice versa.

As soon as the secondary node leaves the coverage area of a primary node without appearing within the coverage area of any other primary node, an alarm may be issued. Depending on the system settings, this alarm may be issued by the primary node that last kept responsibility (e.g., PN_{Y}) or the complete primary network.

To illustrate this further, an exemplary embodiment and/or exemplary method of the present invention may be applied to real-life scenarios, such as, for example, application in car alarms, traveler's luggage and/or a class field trip.

According to an exemplary embodiment and/or exemplary method of the present invention, both a driver's car key and a car alarm may be associated with primary nodes. For example, a suitcase, luggage, and any additional items (e.g., bicycle) to be secured may be associated with secondary nodes. As soon as the driver arrives at the car with the suitcase, the car takes notice of the suitcase in its inventory and assumes responsibility for it. After parking the car in a nearby park, the driver takes the bicycle and leaves the suitcase in the car. The car keys (in the driver's possession) take over the responsibility of the bicycle and release the suitcase. The driver pedals away without the car alarm sounding off because the car alarm “knows” that the car keys took over responsibility for the bicycle. The alarm does not necessarily sound as soon as a secondary node is missing, since primary nodes are “excusable” and with them all the secondary nodes under their responsibility.

According to an example application of an exemplary embodiment and/or exemplary method of the present invention, a couple is going on a trip with four pieces of luggage (e.g., two suitcases, one purse, and one backpack). In this regard, the man and woman are associated with the primary nodes, and the four pieces of luggage are associated with secondary nodes to be monitored. That is, the man and woman may each carry a primary node monitoring device, and the four pieces of luggage may each include a secondary node device that is capable of being monitored. Initially, the man carries the two suitcases and the backpack, the woman carries the purse. Therefore, the link quality between the primary node of the man is best as to the secondary node of the suitcases, but less so as to the secondary node of the purse, while the primary node of the woman has the best link quality as to the secondary node of the purse. This results in the man having responsibility over the suitcases while the woman watches the purse. Now while waiting, the man decides to buy something. So he leaves the suitcases with the woman but takes the backpack. Since now the link quality between the primary node of the woman and the secondary nodes of the suitcases is better than between the primary nodes of the man and the secondary nodes of the suitcases, the woman takes over the responsibility for monitoring the suitcases. This results in no alarm while the man leaves the scene to buy cigarettes.

As an example of the exemplary embodiment and/or exemplary method of the present invention, fifteen students guarded by three teachers go on a field trip. All fifteen students (carrying devices capable of being monitored) are registered within a primary network consisting of the three monitoring devices carried by the teachers. As long as every student node is registered to at least one teacher's device (no matter which one of the three), no warning or alarm will be issued. As soon a one student or a group leaves the coverage of the teacher device it was last registered to and does not show up at any other teacher device within a specified time frame, an alarm will sound.

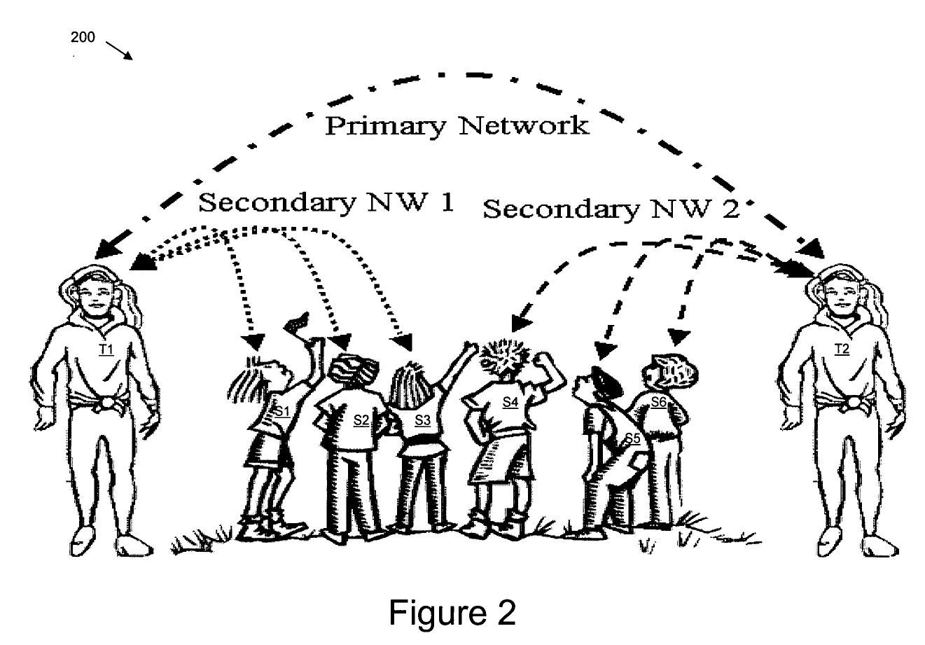

FIG. 2 shows an exemplary wireless mobile security network 200, which includes two primary nodes (teachers T1 and T2) and six secondary nodes (students S1 to S6). Each primary node guards its nearest secondary nodes. Hence, in this instance, teacher T1 guards students S1 to S3, and teacher T2 guards students S4 to S5.

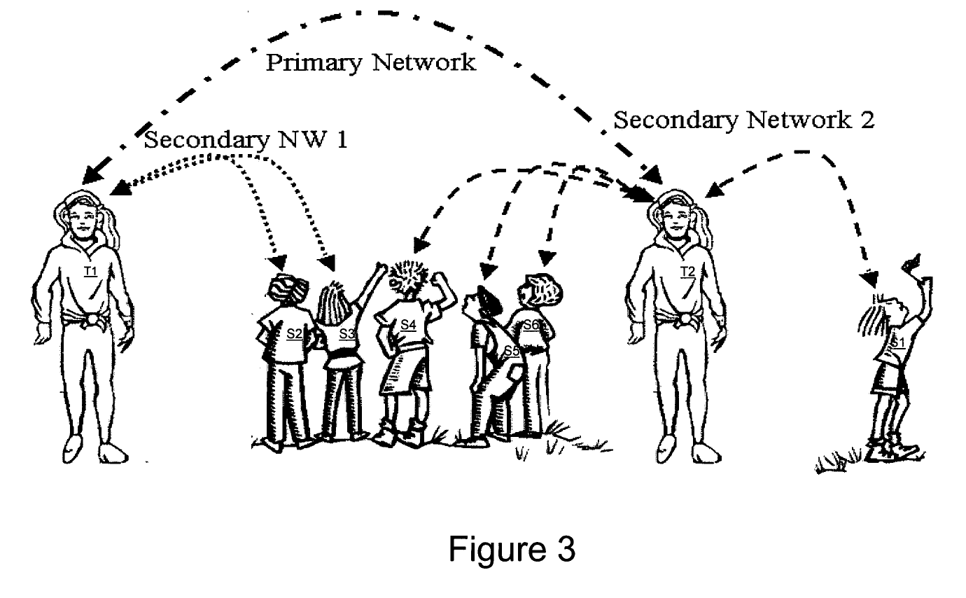

FIG. 3 shows the exemplary wireless mobile security network 200 of FIG. 2, undergoing a change. In particular, upon changing properties in the network 200 (e.g., change in link quality or proximity in location aware networks), one primary node may take over responsibility of one or more secondary nodes previously under the responsibility of another primary node. In this instance, student S1 has wandered closer to teacher T2, so teacher T2 now takes over responsibility for student S1. Proper handover may ensure that the link connectivity is not lost during this maneuver.

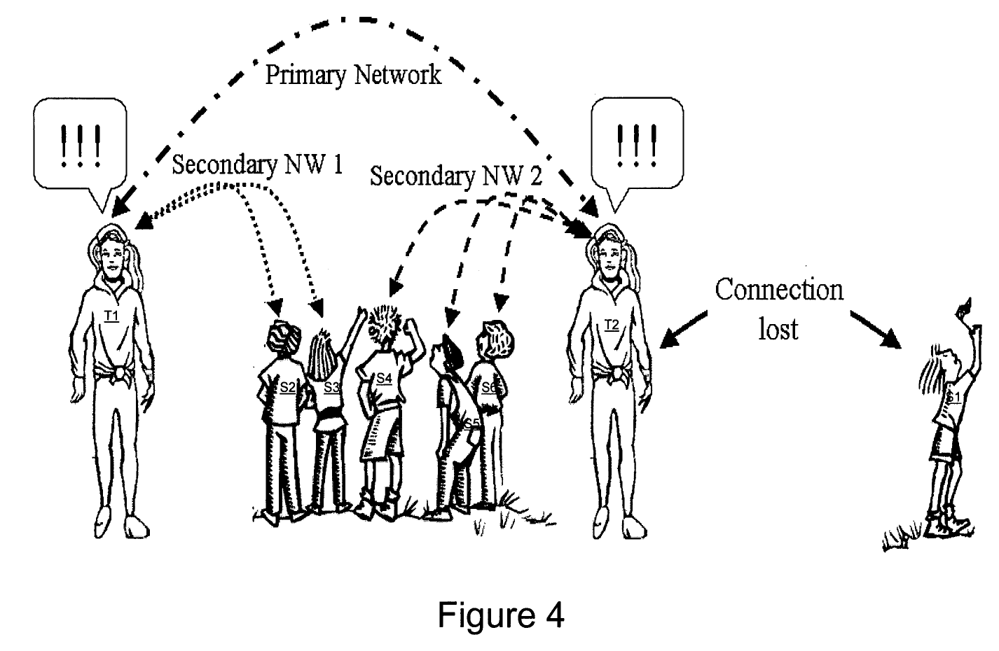

FIG. 4 shows the exemplary wireless mobile security network 200 of FIG. 2, detecting a lost node. In particular, if the network properties change so that connectivity to one or more of the secondary nodes falls below a set value (e.g., link quality of connection or proximity), an alarm will be issued. In this instance, student S1 has wandered outside the coverage of both teacher T1 and teacher T2, so therefore an alarm is sound. Depending on system settings, the alarm may sound, for example, at the primary node last responsible for the now missing nodes or at every primary node.

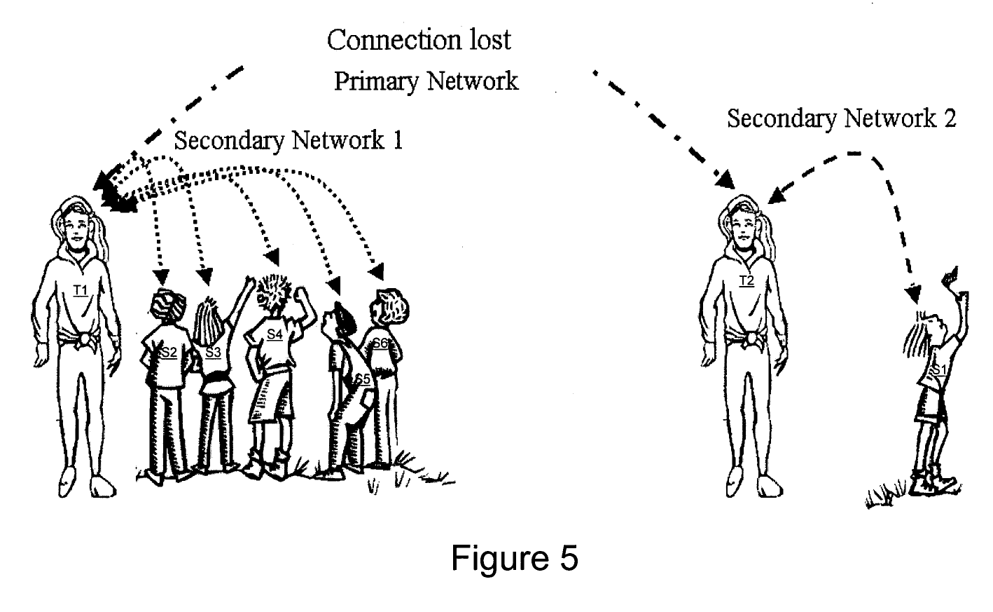

FIG. 5 shows the exemplary wireless mobile security network 200 of FIG. 2, detecting a lost connection between primary nodes. Depending on the system settings it may be tolerated that primary nodes leave the network together with the secondary nodes they are responsible for. A notification may be sent out to the primary and/or secondary nodes remaining in the network. In this instance, teacher T2 leaves the coverage area of teacher T1 to retrieve the lost student S1, and the connection between the two teachers is lost. Accordingly, teacher T1 takes sole responsibility for student S2 to S6, and teacher T2 takes sole responsibility for student S1.

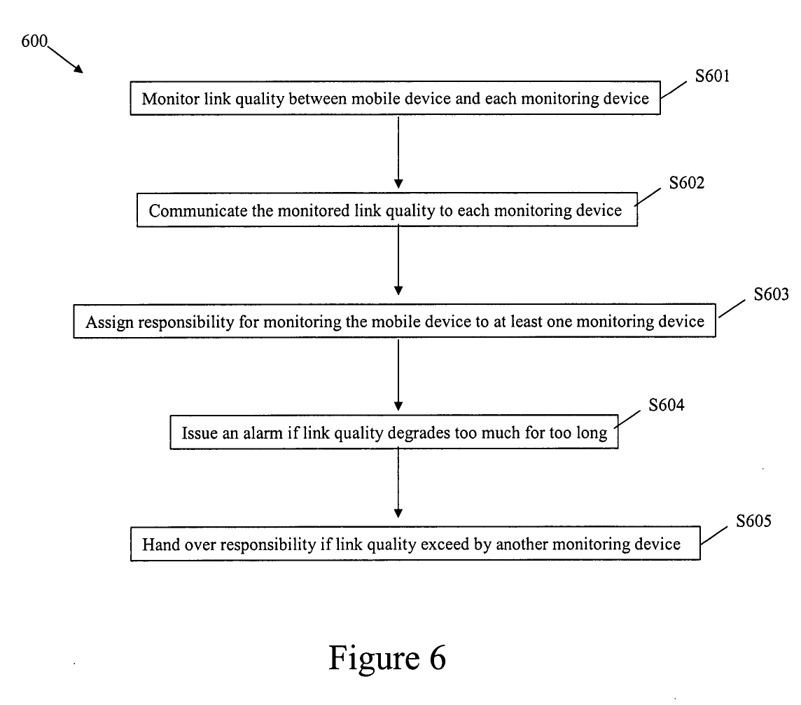

FIG. 6 shows an exemplary method 600 to monitor a mobile device(s) via a plurality of monitoring devices. In this regard, the mobile device(s) may include, for example, a standalone device or device that couples to another device intended to be monitored. The monitoring devices may include, for example, fixed and/or mobile devices. The mobile and monitoring devices may communicate, for example, via one or more wireless protocols.

In step S601, a link quality between the mobile device and each of the plurality of monitoring devices is monitored. In this regard, the link quality may be monitored, for example, asynchronously, in which each monitoring device polls the mobile device, or synchronously, in which each monitoring device listens for a predefined signal from the mobile device at a predefined time period.

In step S602, the monitored link quality between the mobile device and each of the plurality of monitoring devices is communicated to each of the plurality of monitoring devices. In this regard, the monitored link quality may be communicated directly or indirectly to each of the plurality of monitoring devices. For example, each monitoring device may communicate the monitored link quality to the other monitoring devices, or the monitored link quality may be communicated to a central location (e.g., a central node or database), which is accessible by one or more of the plurality of monitoring nodes.

In step S603, one or more monitoring devices are assigned responsibility for monitoring the mobile device based on the monitored link quality between the mobile device and the monitoring devices. In this regard, the monitoring device(s) deemed to have the best overall link quality to the mobile device, or the monitoring device(s) predicted to have the best overall link quality, may be assigned responsibility for monitoring the mobile device.

In step S604, an alarm is issued if the link quality between the mobile device and the monitoring device assigned to monitor the mobile device falls below a predefined value for a predefined time period. In this regard, the predefined value and time period may be configurable to accommodate more than one type of mobile device. Furthermore, the alarm may be issued in any suitable form, including, for example, in the form of an audible alarm or in the form of an electronic notification message.

Finally, in step S605, the monitoring device assigned to monitor the mobile device hands over to a non-assigned monitoring device responsibility to monitor the mobile device if the link quality between the mobile device and the non-assigned monitoring device exceeds the link quality between the mobile device and the assigned monitoring device for a predefined time period. In this regard, the monitoring device may assign responsibility to the non-assigned monitoring device using, for example, a wireless handover protocol.

1. A mobile security network, comprising:
a plurality of primary mobile nodes; and
at least one secondary mobile node dynamically assigned to be monitored by one of the plurality of primary mobile nodes,
wherein the plurality of primary mobile nodes communicate with each other to hand off responsibility for monitoring the at least one secondary mobile node, and monitor a link quality between themselves and any assigned secondary mobile nodes, and wherein the network is configured to issue an alarm if a link quality between a secondary mobile node and its assigned primary mobile node falls below a predefined value for a predefined time period, and a link quality between the secondary mobile node and all non-assigned primary mobile nodes does not exceed the predefined link quality.

2-5. (canceled)

6. A mobile security network comprising:
a device to be monitored; and
a plurality of monitoring devices to monitor the device to be monitored,
wherein the device to be monitored and the plurality of monitoring devices are mobile devices;
wherein the plurality of monitoring devices are configured to monitor a link quality with respect to the device to be monitored and communicate the monitored link quality to at least one other monitoring device;
wherein a monitoring device is assigned responsibility for monitoring the device to be monitored based on the link quality between the device to be monitored and each of the plurality of monitoring devices; and
wherein the assigned monitoring device hands over responsibility to monitor the device to be monitored if the link quality between the device to monitored and a non-assigned monitoring device exceeds the link quality between the device to be monitored and the assigned monitoring device for a predefined time period.

7-8. (canceled)

9. The mobile security network of claim 6, wherein the monitoring device assigned responsibility for monitoring the device to be monitored is configured to issue an alarm if the link quality falls below a predefined value for a predefined time period.

10. The mobile security network of claim 6, wherein a monitoring device not currently assigned responsibility for monitoring the device to be monitored is configured to issue an alarm if the link quality falls below a predefined value for a predefined time period.

11. The mobile security network of claim 6, wherein the assigned monitoring device hands over responsibility to monitor the device to be monitored based on the link quality between the device to be monitored and each of the plurality of monitoring devices.

12. (canceled)

13. The mobile security network of claim 6, wherein the device to be monitored includes an item of personal property.

14. The mobile security network of claim 6, wherein the device to be monitored is configured to be coupled with an item of personal property.

15. The mobile security network of claim 6, wherein the monitoring devices are configured to be at least one of worn and carried by a person.

16. The mobile security network of claim 10, wherein the monitoring devices are configured to be integrated with a vehicle security system.

17. A method of monitoring a mobile device via a plurality of monitoring devices, comprising:
monitoring a link quality between the mobile device and each of the plurality of monitoring devices;
communicating the link quality between the mobile device and each of the plurality of monitoring devices to each of the plurality of monitoring devices;
assigning a monitoring device responsibility for monitoring the mobile device based on the link quality between the mobile device and the monitoring device;
issuing an alarm if the link quality between the mobile device and the monitoring device assigned to monitor the mobile device falls below a predefined value for a predefined time period; and
handing over to a non-assigned monitoring device responsibility to monitor the mobile device if the link quality between the mobile device and the non-assigned monitoring device exceeds the link quality between the mobile device and the assigned monitoring device for a predefined time period.

18. The method of claim 17, wherein the mobile device and the plurality of monitoring devices are wireless devices.

19. The mobile security network of claim 1, wherein the plurality of primary mobile nodes and the at least one secondary mobile node are wireless devices.

20. The mobile security network of claim 6, wherein the device to be monitored and the plurality of monitoring devices are wireless devices.

21. The mobile security network of claim 1, wherein a primary mobile node assigned to monitor a secondary mobile node hands over responsibility to monitor the secondary mobile node if the link quality between the secondary mobile node and a primary mobile node not assigned to monitor the secondary mobile node exceeds for a predefined time period the link quality between the secondary mobile node and the primary mobile node assigned to monitor the secondary mobile node.
